(19) United States
(12) Patent Application Publication
(10) Pub. No.: US 2004/0117231 A1
(43) Pub. Date: Jun. 17, 2004

(54) Interactive implementation and representation of state of operative planning processes

(76) Inventors: Edgar Jochheim, Munchen (DE); Karsten Konigstein, Seefeld (DE)

Correspondence Address: Joseph W. Berenato III, Liniak Berenato & White, Suite 240, 6550 Rock Spring Drive, Bethesda, MD, 20817, US

(21) Appl. No.: 10/466,265

(22) PCT Filed: Nov. 5, 2001
(86) PCT No.: PCT/EP01/12781

(30) Foreign Application Priority Data
Jan. 15, 2001 (EP) 01 100 833.1

(51) Int. Cl. G06F 17/60

(52) U.S. Cl. 705/8

(57) ABSTRACT

For the interactive implementation of innovation processes on a computer network (8) the individual steps of an innovation processes are present in the form of modules (9, 10) connected with each other via standardised interfaces, that each have at least one sub-program. When a step is executed the sub-programs required are automatically invoked and the output data from the sub-programs are passed to a central database (1), to other sub-programs of the same module and/or to at least one further module.

The present invention concerns a method and a system for interactive implementation of operational planning processes using a computer network and methods for displaying the current status of operational planning processes.

The present invention concerns in general operational planning processes, such as sales, production, marketing and innovation planning, possibly in association with expert networks, an idea management system and automated planning data control function.

In the following the background to the invention will be explained using the example of innovation processes. The development of a new product or in general an innovation from the problem setting or idea finding steps to the finished developed product or the completed innovation within a company can be summarized by the term “innovation process.” Nowadays in virtually all areas of a modern company the operational processes are to a large extent supported by computer networks and software or are performed with the help of these.

The supporting and organising of the execution of such innovation processes by planning software is known from prior art. Apart from this, software is also used in order to perform certain tasks within such an innovation process. The innovation process itself can, as in the prior art, be subdivided into a number of process steps, which depending on the industry the company is in and the corporate culture as well as the size and organisational shape of the company are linked together in different ways. The individual process steps each require information in the sense of necessary data and furnish results that are to some extent very different in nature, which also represent data. Accordingly, each process step has input data and output data. The performance of a process step takes place conventionally without software, with the support of software or completely using software.

Here the software comprises for each process step one or more programs that may originate from various producers and can only communicate with each other in a very incomplete manner, since data formats are not compatible or the linking of the programs in the necessary way is not provided for (“heterogeneous environment”). Furthermore, planning of the entire innovation process takes place using planning software. Here the individual process steps of an innovation process are mostly represented graphically and there is the possibility, in particular, of displaying the progress over time of an innovation process and to match the timing of the individual process steps to one another. This is how the workflow planning is performed.

A disadvantage of this known state of the art is that the innovation process in a company is not supported by a single interactive software tool. It is not possible from the planning software to directly invoke the software needed for a process step. The disadvantage here is that time delays occur, since information cannot be passed directly from one program to another where it is needed. The data formats are not compatible. Furthermore, an adaptation to the status of the innovation process reached will always be complicated, and to some extent is only possible with manual input, since the results of the work are stored independently of the planning software and this cannot recognise that a certain process step has been completed without corresponding manual input.

Because of these restrictions it is also necessary that process steps that really at least in part could run simultaneously, are nevertheless executed sequentially, since a fast and flexible adaptation of the input data of one process step to reflect the most up to date output data of the other process step cannot take place fast enough. Finally control, for example from the point of view of the costs incurred to date, the results to date, or the scheduling and the company resources needed, is difficult, since the information necessary for this must first be gathered from various sources and must be input into the software used for control.

Putting together an overall system from planning software and the programs necessary for individual process steps and to match this to the individual company processes is very involved, although basic models of an innovation process exist that are known for certain areas and company situations.

In Stefan Jablonski “Workflow Management: Development of Applications and Systems, Facets of a New technology” dpunkt-Verlag, Heidelberg 1997, ISBN 3-920993-73-X the application of implementation techniques for integration of external applications is presented.

Application integration means the incorporation of external application programs into the workflow execution. They are represented in the workflow schema by workflow applications. Application programs are used to perform tasks. In particular, application programs that were previously being used before the introduction of a workflow management system must also continue to be available.

Application integration can be considered from various perspectives. The workflow metaschema model provides that workflow applications will be called upon to perform tasks, i.e. the performance of a task is a functional requirement. A direct result of this is that the application programs assigned to the workflow applications must be incorporated in the workflow execution whereby the technical conditions must be taken into account. But it is not just the unidirectional integration that has to be supported, but also the inter-operability between workflow management system and application program. Apart from these functional requirements remote invocation and reliability of application programs are important non-functional requirements.

In most cases, with the exception of automatically executed programs, a user is involved in the execution of an application program. Each user must be able locally at his work station, to process the tasks assigned to him, i.e. he must be able to control application programs that are necessary for execution of his tasks, locally from his work station. It is not acceptable for a user to have to leave his work station in order to process a task. Put in general terms, this means that access to all application programs with the potential for integration must be possible from any work station. This calls for remote invocation of the programs and communication between generally heterogeneous systems which leads to problems when meeting this requirement. The work stations of the users are equipped with different operating systems, operating system versions, configurations, user interfaces and network connections. Thus for remote invocation in addition to the invocation mechanisms of the programs the heterogeneity of the hardware must be taken into account. If an interactive program is involved, then dialog between user and program must be enabled on the local computer. In some cases another graphical user interface for the program is necessary here, if installed on the local computer of the user.

Integration must be enabled for each invocation mechanism. Programs can, for example, be invoked by operating system invocation, CORBA and RPC.

CORBA is a general object request broker, that was developed by the Object Management Group. CORBA defines a distributed architecture in which objects cooperate via an open software bus. These objects also communicate with each other even if they originate from various manufacturers or work under different operating systems.

RPC is a protocol developed by SUN for OSI levels 5 and 6 and guarantees remote function invocation. Each server on the network makes available within the context of this concept a number of services that can be invoked using RPC. These functions are executed as procedures of a program and can be invoked by specifying the server address, program number and procedure number. RPC is described in RFCs 1057 and 1831.

To begin with the commercial workflow management systems “WorkParty” from SNI, “COSA” from Software-Ley and “FlowMark” from IBM will be investigated for the possibilities they offer for application integration.

“WorkParty” makes a distinction between integrated and non-integrted programs, whereby the term integration has a different meaning here from that of the integration of the application. Programs are said to be integrated when the transfer of input and output parameters is possible. These include any executable programs that are invoked via the operating system. However, it is not completely clear from the documentation here what operating systems are supported and if apart from the local program invocation, the invocation is also possible. Apart from the invocation of a program, a sequence of programs can also be invoked. WorkParty thus supports only the integration of a limited number of programs, whereby parameter transfer is not possible with all these types of programs.

COSA allows the invocation of programs at operating system level only. Here as early as when the specification is prepared it is determined whether invocation takes place on the client computer or on the server. This wording leads to the conclusion that remote invocation from another client is not possible. A number of operating systems are supported. Server and client are available for UNIX and VMS, clients are also available on the PC operating systems MSDOS, MS-Windows and OS/2. Thus all programs that are executable on these operating systems and can be started by means of operating system invocation can be integrated. A program sequence can also be specified, whereby the individual programs in turn are subject to the said restrictions and programs on client and server should only be contained in the sequence in a precisely specified order.

FlowMark allows the integration of a number of different types of program. The group includes executable OS/2 files, OS/2 command and DLL files, executable MS DOS files and MS DOS command files, executable MS-Windows files, MS-Windows command and DLL files, executable AIX files and AIX shell scripts, the FlowMark Bundle Planning tool, the FlowMark iManual Checklist program and the Application Support Facility, which allows programs to be started on a host system. Input parameters can be passed to OS/2, MS-Windows and AIX programs as command line parameters. How output parameters can be made available from these programs is not stated in the documentation. The IBM service broker concept also allows the integration of further products. Service brokers for Lotus Notes, VisualInfo and VisualAge are available. Apart from this it is possible to program service brokers for other products. Using the building block principle, integration programs can be generated that use the published interfaces of the product to be integrated and of FlowMark. FlowMark makes such a building block available, which allows communication between two FlowMark systems via MQSeries. Here queues are used for the sending and receiving of messages.

Finally the research prototype MOBILE is considered. The integration of the application programs in the workflow execution is simplified considerably if these support a common interface. For this purpose a wrapping mechanism is needed. For the implementation a genetic and service-independent proxy mechanism is suggested. A program is concealed by an object that specializes in supporting remote invocations in a proxy and an implementation object. The implementation object is located on the machine in which the associated program can be executed. The proxy object is part of the work list of a user. With this approach, for example, the integration of programs that are invoked via TRPC is also possible.

From DE 42 10 615 A1 and the largely identical U.S. Pat. No. 5,423,023 a method and a device are known for the provision of a user-configurable system that combines and manages a number of different software tools. Here at least some software tools are incompatible with the system. Here control macros are used to encapsulate the incompatible software tool and all transfers to and from this tool are interpreted as necessary.

This prior art does not, however, describe a system that supports an innovation process on a computer network. Above all there is no comprehensive data backup and storage.

EP 0 489 351 B1 discloses a software tool for minimizing the effort and trouble in the automatic execution of software operations on the basis of work information in an independent further developed design. Here the software tool has a work knowledge store, in which work information is stored. A software operating device performs an operation in a large number of programs.

This prior art, however, does not provide a solution to the problem of interactive implementation of an operational planning process.

The object of the present invention is therefore to provide a technique that allows planning processes to be executed within a company with system integration. It also comprises the need for complete and therefore secure storage without the danger of a loss of know-how of work results and data from planning processes.

This problem is solved by the characteristics of the independent claims. Advantageous designs and further developments are shown in the sub-claims.

In a method for interactive implementation of planning processes on a computer network, therefore, when a step is executed the necessary sub-programs are automatically invoked, whereby the individual steps of a planning process are present in the form of modules that are connected with one another via standardised interfaces. As a rule these each have at least one sub-program, whereas modules are also possible that instruct just manual steps and therefore require no sub-programs. The output data from the sub-programs or manually executed steps are passed to a central database, to other sub-programs of the same module and/or to at least one further module.

Here the interactive implementation can also include the integration of corresponding input possibilities such as interactive whiteboards, flipcharts, etc., via an integrated software application.

At least some of the modules can thus have no sub-programs and just instruct actions to be performed manually by the user.

At least some of the modules can offer the user several sub-programs, so that the further sequence is dependent upon the selection of the user.

Advantageously, therefore, in a single process the entire planning process within a company can be supported by software or actually performed by it. Here individual tasks or processes of the planning process that need to be performed, referred to here as steps, may require certain software that is to some extent available off the shelf. This sub-program or also a number of sub-programs are contained in a module assigned to the step and can advantageously be invoked directly and here contain the necessary data without any further action or operation by the user. With an inventive process, therefore, the data for a number of different sub-programs that are needed are conveniently managed and held centrally in one database.

Advantageously the modules can be exchangeable with industry-specific and/or company-specific modules.

In this way the process can be quickly adapted for different companies, since fixed, regularly repeating basic models of a planning processes can be created for certain industry and company situations by corresponding modules.

Status data that reflect the internal states of the sub-programs or modules, can be provided for quality, time and/or cost control assessment. Here for at least some of the status data threshold values can be specified and when these threshold values are reached in the course of the execution of the planning process a message is automatically generated and output.

In this way it is possible to quickly and securely determine that intermediate targets have been reached. A message can be associated with reaching defined intermediate targets or milestones, which can also trigger other actions. For example, such a message can release another step and it only then be permitted in the corresponding module to invoke a sub-program or also to execute a process step in the conventional way without the use of software.

An override mode can be provided for that allows the further steps to be continued with even if the threshold values have not yet been reached. Activation of the override mode will sensibly require the user to have the corresponding authorization status.

The method can also have the following steps:

picking up of status data at predefined points of the process;

evaluation of the status data picked up according to a predefined model, and

visualization of the evaluated status data to display the status of the process.

Here a model for evaluating the status data picked up can be created and/or modified by the user.

Advantageously, if an end date of the planning process is specified on the basis of the time remaining between the current and the end date, for all steps of the planning process desired times or intermediate dates can be calculated according to a known distribution code, for example one based on empirical values.

In the event of a deviation from the desired times all intermediate dates of steps that are affected by this can be recalculated.

In an advantageous embodiment the process is applied to a computer network that is at least in part the Internet, whereby the data exchange with sub-programs or modules takes place via the Internet. Equally intranets and/or extranets can be used.

In this way certain steps that are required seldom or only once by a company, because there is only a need for them for individual planning processes, can be easily and flexibly incorporated into the planning process. Above all these cases do not need to be fundamentally incorporated in the process, because if they are not actually needed the software that is used by the process has an unnecessarily broad scope. It is also possible to only charge for steps and the associated services that are only used in case of need, if they are actually used.

All process-related data are kept available in the system itself, so that for example each process can be analysed in retrospect. Process-related data are therefore only exported externally as a copy.

A system for interactive implementation of a planning process that is defined by a sequence of process steps, can have a graphical user interface and an application server that provides the software tools necessary for the execution of the process step, and a database, which exchanges standardised input and output data for the software tools with the application server and manages these input and output data. The application server provides status data that indicate internal statuses of the steps of the planning process and a project management module evaluates the status data for quality, time and/or cost control purposes.

The application server can provide status data that indicate the current status of the planning process.

The software tools can be provided as an alternative or in addition to the database server.

A project management module can be provided that evaluates the status data and/or other resources for quality, time and/or cost control, etc.

The system can have an integrated idea management module.

Finally the system can have an integrated expert network.

The planning and use of the system can thereby take place by means of decentralised virtual subscribers.

The computer network of the system described can at least to some extent be the Internet and sub-programs or modules connected over the Internet.

The present invention is explained in more detail in the following with reference to the attached drawings, which show the following:

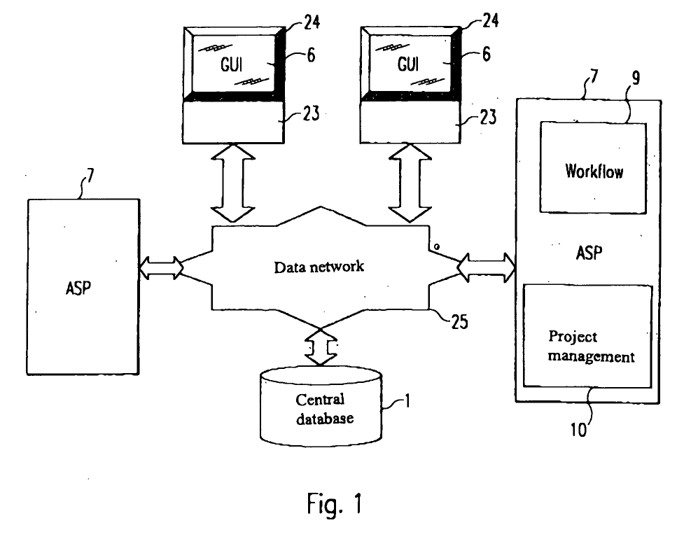

FIG. 1: a schematic representation of a system for interactive implementation of an operational planning process according to the present invention;

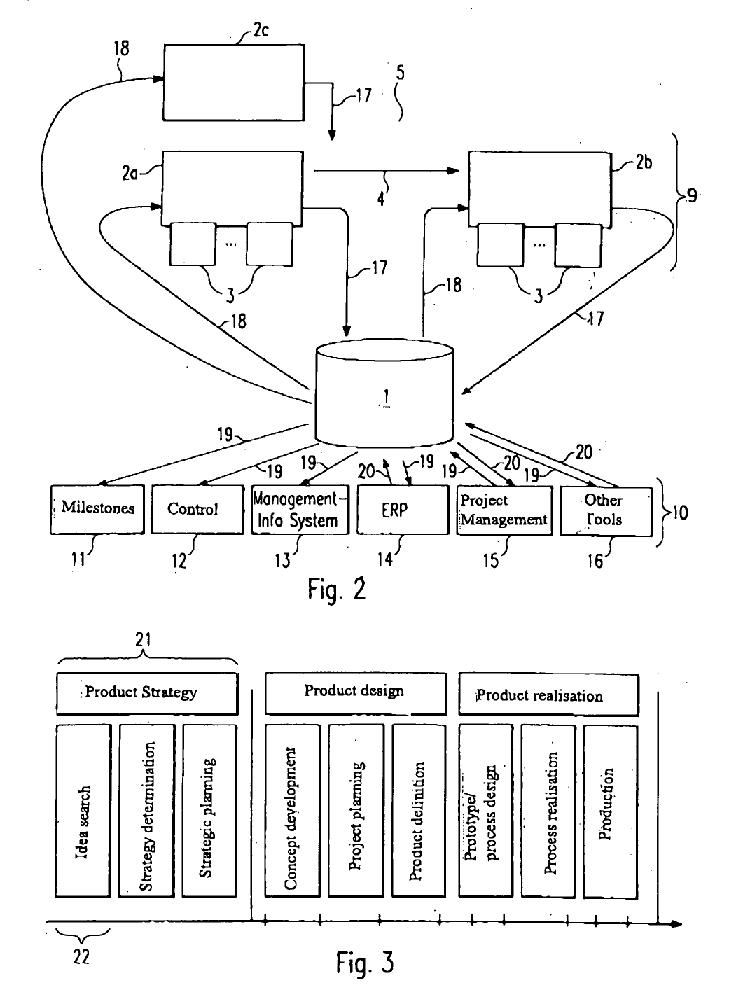

FIG. 2: a diagram, that shows the execution of two steps of a planning process;

FIG. 3: a representation of the sequence of the planning process as a graphic overview of a user interface; and

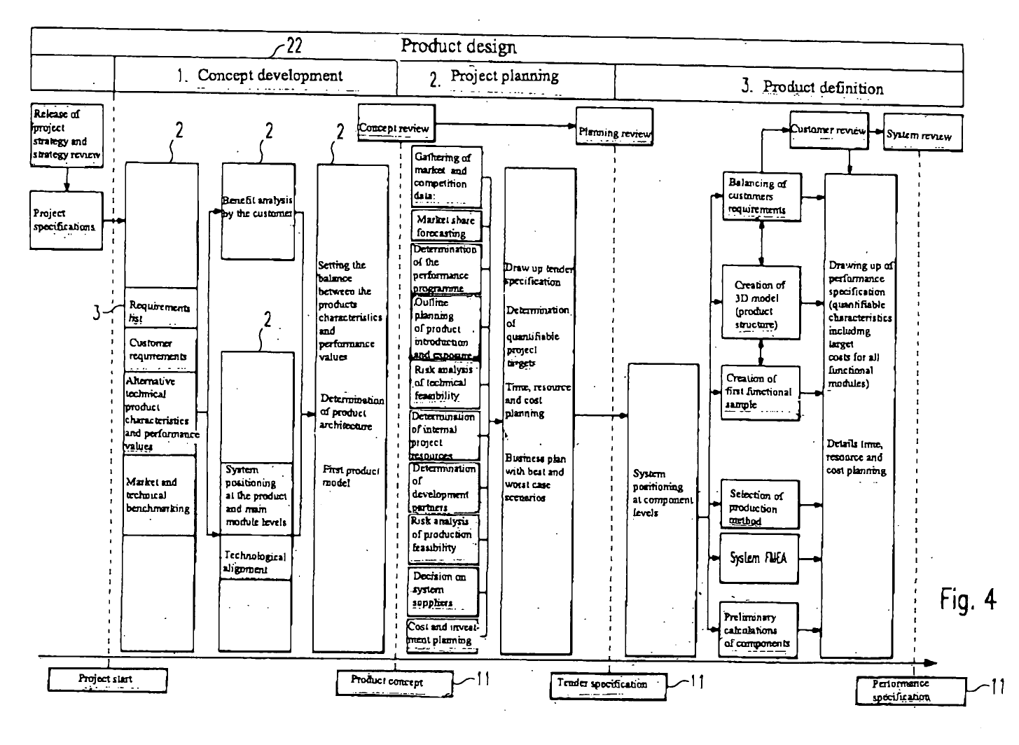

FIG. 4: an extract from the graphic in FIG. 3 as a detailed representation of the user interface with individual steps of the planning process.

As already mentioned at the outset, the present invention can be generally used for the planning processes in a company such as sales, production, marketing and innovation planning. These planning processes can thereby run within the company but also on a company-wide basis. In the following the background to the invention is explained using the example of innovation processes which, however, shall not represent any restriction of the possible scope of application of the present invention.

FIG. 1 is a schematic diagram of an implementation of the present invention. According to FIG. 1, at least one ASP server 7, one central database 1 and at least one terminal (client (23), having a monitor 24, communicate with each other by means of a network 25, that for example can be an intranet or also the Internet.

The application server technique (ASP) as such is of course well known. ASP servers 7 offer application oriented services. All applications thereby run on ASP servers 7. Thanks to the data network 8, the terminals 23 can obtain software functions online from the ASP server 7. The complexity of the software and the computing power at the terminal 23 itself is thereby reduced and shifted to the data network 8. For companies the advantage of the ASP technique used in the present invention lies in greater economic efficiency, improved calculation capability of the computer power and reduced capital commitment. Software maintenance, updates and further development take place at central points (ASP servers 7) and are made available to the user of a terminal 23.

At the same time connections via the Internet, intranet and/or extranet are possible. Windows Net-Meeting client software from Microsoft can be used allowing video conferencing on the Internet. For this the user's terminal requires a sound card and a video camera with an interface for Video for Windows and Net Meeting. For example, by means of ISDN and Windows 95 or NT TCP/IP-stack an Internet link is set up. With Net Meeting dialling in takes place to an Internet video conference server. This allows, inter alia, application sharing and file transfer. Thus the planning and execution of the inventive system can take place via decentralised subscribers or decentralised teams.

FIG. 2 shows a three-layer structure of a system for interactive implementation of an innovation process according to the present invention. The three layers include a graphical user interface (GUI) 6 on the terminal 23, at least one application server (ASP server) 7 and a central database 1, that exchanges data with the ASP server 7.

The GUI 6 offers the user of the terminal 23 a visual interface with symbols (icons) for various resources and programs. It also contains the controls and display elements of a program or operating system (in addition to icons, dialog boxes, menus and windows), that simplify usage.

In addition, for interactive implementation, the incorporation of corresponding graphic input possibilities such as interactive whiteboards, flipcharts, etc. can also take place via an integrated software application.

For the execution of an innovation process, workflow and project management need to be regularly defined. Accordingly on an ASP server 7 a workflow module 9 and a project management module 10 are installed. To be more specific, the software application programs (software tools) 3 required for a workflow module 9 and a project management module 10 are stored on at least one application server 7.

In addition the workflow module specifies a sequence of individual process steps according to a set scheme, in order to interactively implement the actual innovation process. The innovation process defined by the steps of the workflow module 9 can thus be modelled by means of the application server 7 on an intranet of a company. Each individual process step is defined by its input data (input), its content, its processing and its output data (output).

The project management module 10 allows monitoring and control of date, cost and quality targets and/or other company resources in the course of the innovation process and thus parallel to and simultaneously with the individual processing steps according to the workflow module 9 of the innovation process.

FIG. 2 is a schematic representation of the execution of two steps of an innovation process 5 by corresponding sub-modules 2a, 2b of the workflow module 9. The output data 17 of a sub-module 2a are stored in the database 1. Alternatively or additionally they can also be passed directly (4) to a subsequent sub-module 2b. Input data 18 for a sub-module 2b can then in turn be invoked from the database 1.

Management of the input and output data of the sub-modules 2a, 2b thus takes place in the central database 1. Each of the sub-modules 2a, 2b corresponds to a step of the innovation process and models (implements) these interactively by means of the corresponding software tools 3 on an intranet, whereby the software tools 3 are made available on at least one application server 7 on the data network 25, whereby the application can run on a database computer. The process steps can be the most varied of tasks or processes to be performed within the context of such an innovation process. Merely by way of examples mention is made of processes such as planning production of a model, creating a functional sample, deciding on a supplier or market share forecasting.

The sub-module 2c shows that sub-modules do not necessarily have to run sequentially but can at least in part run in parallel with each other.

In order to perform the individual steps that correspond to each of sub-modules 2a, 2b, sub-steps must be executed. These sub-steps are performed by corresponding software tools 3. When a step is invoked by means of the graphical user interface 6 the user is thus, for example, shown the sub-steps necessary to perform this step as, for example, an HTML document. If the user then wishes to perform one of these sub-steps, he selects this, as a result of which the necessary software tools 3 on the application server 7 are invoked and if necessary pre-existing input data that is necessary to perform the corresponding sub-step is invoked from the database 1.

Alternatively this step can also take place semi-automatically or completely manually. With the semi-automatic procedure the user is provided with various options concerning the software tools 3, which represent options for performing the corresponding sub-step. The user can then select one of these options.

With the manual procedure the user must perform actions himself without software tools being provided.

With the help of these software tools 3 the user can thus execute the sub-steps, whereby (intermediate) results that are generated in each case are stored centrally in the database 1 and as needed invoked from this again, in order for further use to be made of them in other steps and/or sub-steps. This further use can also be an evaluation on a monitor.

The data handover between the individual software tools, sub-modules and to/from the database 1 takes place in a uniform, standardised manner. This has a number of advantages:

the database 1 manages a uniform format;

in order to adapt the innovation process the sub-modules can be combined or added to almost at will in a modular fashion, and

pre-existing applications within the company concerned can be used as software tools, and can be incorporated into the sub-modules of the innovation process if necessary using a format conversion.

The data flows are shown by arrows 4, 17 and 18 in FIG. 2. The output data of a sub-module are converted again into the uniform data format of the central database 1 and stored there. If now due to a necessary change to the product under development, for example an additional component is needed, then this has effects on the subsequent steps of an innovation process, such as cost calculation, purchase or supplier selection. For another employee who is working on this step, for example in sub-module 2b, the changes are then rapidly available via the input data from the central database 1. The innovation process can thereby be accelerated considerably.

All process-related data are kept constantly available in the system, for example in the central database 1, so that, for example, each process can be analysed in retrospect. Process-related related data are therefore only exported externally as a copy.

Because the modelling of the innovation process on the intranet takes place through chaining of software tools with standardised and exchangeable interfaces, a rapid adaptation to the constraints that exist within an industry and/or a company can take place.

If the method is to be applied to a company in a particular industry and then, for example, another CAD program that is available is to be used, an adaptation is simple to perform, since modules 2a and 2b exchange their input data and output data with the database 1 via standardised interfaces. One module can therefore be easily exchanged for another, in order to implement an amended innovation process.

The project management module 10 allows the monitoring and control of time, quality and cost targets of the innovation process and control of other company resources. With this project management module 10, which is either part of the innovation process itself or is linked to this as software tools 3, therefore by way of example monitoring of expenditure to date or time planning can take place. To this end data stored in the central database 1 are handed over to the software tools 3 of the project management module 10.

Output data from at least certain software tools of the project management module 10 can also be handed back to the database 1. Thus results from the project management module can, if necessary, also be used in sub-modules 2a, 2b and 2c of the workflow module that may also follow on from one another later or immediately.

Example of the software tools of the project management module 10 are:

a milestone generation unit 11, which indicates that specified milestones of the innovation process have been reached. The percentage of the results of a sub-module that have already been processed can, for example, be conveyed in the form of a traffic light signal or other graphic or visual display to the user;

a control unit 12 that allows cost control;

a management information system 13;

an ERP (enterprise resource planning) unit 14, for planning the resources of the company;

the actual project management unit 15, and

other tools 15.

The milestone generation unit 11 is just one example of how the status of the process can be displayed, for example graphically. For this purposes status data, which indicate the internal statuses of the sub-programs or modules are provided, for example for quality, time and/or cost control evaluation.

The process can thereby, for example, run as follows:

automatic picking up of status data at predefined points of the process;

evaluation of the status data picked up according to a specified model, and

visualization of the evaluated status data for display of the status of the process.

Thus the status of the process can be graphically modelled according to certain requirements. For example, so-called scorecards can be automatically generated. In the case of an innovation process such a scorecard can, for example, contain the number of ideas generated, the product development duration or the amount of R&D works, etc.

The model for evaluation of the status data picked up can thereby be generated and/or modified by a user, so that, for example, scorecards can be modified according to the wishes of a user.

The actual project management unit 15 allows specification of dates and date planning. For this purpose an end date is specified and the project management unit 15 divides up the remaining time until this end date according to a certain code among the individual sub-modules 2a, 2b and 2c of the innovation process. In the event that in a sub-module such a predefined intermediate date is exceeded, within the context of dynamic scheduling the intermediate dates are automatically and correspondingly modified in those sub-modules which have to rely upon the output data whose intermediate date has not been met.

Only if a sub-module has been fully completed or a specified percentage of results of a sub-module has been reached, is the processing of the sub-module or the ones that follow it enabled.

An override mode can, however, be provided for that allows the further steps to be continued with even if the threshold values have not yet been reached. Activation of the override mode will sensibly require the user to have the corresponding authorization status.

FIG. 3 shows various phases 21 of the innovation process, as they are presented to the user on the graphical user interface (6 in FIG. 1). These main phases 21 of the innovation process can, for example, include product strategy, product design and product realization. These main phases 21 can in turn be subdivided into sub-phases 22. The product strategy main phase 21 can, for example be subdivided into the sub-phases of searching for ideas and evaluation of ideas, determination of strategy and strategic planning. The product design main phase can be subdivided into concept development, product planning and product definition.

The product realization main phase can be subdivided into prototype/process design, process realization and production.

FIG. 4 shows the detailed subdivision of the innovation process. Within the various sub-phases 22 the sub-modules 2 can be identified that run in part sequentially and in part in parallel with each other. In the concept development sub-phase, for example, the “benefit analysis by the customer” and “system positioning at the product and main module levels” and “technological alignment” are executed simultaneously. The sub-modules 2 can in turn be subdivided into the steps to be completed and the associated software tools 3.

FIG. 4 also shows how at certain points in time, in particular following completion of a sub-phase 22 of the innovation process, so-called milestones 11 can be generated. These milestones can, for example, be at the end of the “concept development” sub-phase the “product concept”, at the end of the “project planning” sub-phase the “tender specification” milestone and at the end of the “product definition” sub-phase the “performance specification” milestone.

Participants in the innovation process can be notified automatically by means of e-mail, telephone or SMS text message.

The data occurring in the innovation process can also be converted into and output in formats (WAP, GPRS, UMTS, etc.) for mobile communications applications.

The system specified above can also be easily connected to management planning software which organizes daily tasks and for the participants in the innovation process generates automated suggestions for prioritization of activities concerning the innovation process.

1. Method for implementing operational planning processes on a computer network (25), whereby
the individual steps of the planning process have modules (9, 10) on a central ASP server (7), which users of terminals (23) access via the computer network (25),
each module (9, 10) represents a sequence of individual process steps,
in order to execute a module (9, 10) from a terminal (23), that is linked via the computer network (25) with the ASP server (7), the corresponding module (9, 10) is invoked by means of a graphical user interface (6) on the terminal (23) and thereby application programs (3)
in the ASP server (7) necessary for the execution of the module (9, 10) are automatically invoked,
the process data resulting from the execution of a module (9, 10) are handed over to a central database (1), and
the process data present in the central database (1) are invoked again during the execution of a subsequent module.

2. Method for interactive implementation of planning processes according to claim 1, characterised in that the modules (9, 10) can be exchanged for industry specific and/or company-specific modules.

3. Method for interactive implementation of planning processes according to claim 1 or 2, characterised in that the status data (19), indicating the internal statuses of the sub-programs (3), or modules (9, 10), are made available for cost control assessment.

4. Method for interactive implementation of planning processes according to any of the above claims, having the following steps:
picking up of status data at predefined points of the process;
evaluation of the status data picked up according to a predefined model, and
visualisation of the evaluated status data to display the status of the process.

5. Method according to claim 4, characterized in that the model for evaluating the status data picked up can be adjusted and/or modified by a user.

6. Method for interactive implementation of planning processes according to any of claims 3 to 5, characterised in that for at least part of the status data threshold values are specified and when these threshold values are reached in the course of the execution of the planning process a message or action is automatically generated and output.

7. Method for interactive implementation of planning processes according to claim 6, characterised in that only once the message has been output are the further steps of the planning process enabled.

8. Method for interactive implementation of planning processes according to claim 7, characterised in that an override mode is provided that allows the continuation with the subsequent steps even if a threshold value has not yet been reached and the corresponding message has not yet been received.

9. Method for interactive implementation of planning processes according to claim 7, characterised in that an activation of the override mode requires a corresponding authorization status.

10. Method for interactive implementation of planning processes according to any of the above claims, characterised in that an end date for the planning process is specified and on the basis of the time remaining between the current and the end date, for all steps of the planning process desired times or intermediate dates can be calculated according to a known distribution code, for example one based on empirical values.

11. Method for interactive implementation of planning processes according to claim 10, characterised in that if the calculated intermediate dates are exceeded, or a step is completed before the interim date, all interim dates of steps that are affected by this are recalculated.

12. Method for interactive control of a planning process according to any of the above claims, characterised in that the computer network is at least in part the Internet and data exchange with sub-programs or modules takes place via the Internet.

13. Method according to any of the above claims, characterised in that the computer network is at least in part an intranet, extranet or other computer network and via which the data exchange with sub-programs or modules takes place.

14. Method according to any of the above claims, characterised in that all process-related data are kept available.

15. Method according to claim 14, characterised in that the process-related data is only exported externally as a copy.

16. Method according to any of the above claims, characterised in that at least some of the modules have no sub-programs and instruct only actions to be performed manually by the user.

17. Method according to any of the above claims, characterised in that at least some of the modules offers the user several sub-programs, so that the further sequence is dependent upon the selection of the user.

18. Method according to any of the above claims, characterised in that for the interactive implementation interactive graphic input possibilities, such as interactive whiteboards, flipcharts, and so on, are incorporated via an integrated software application.

19. Method according to any of the above claims, characterised in that the planning and execution takes place by means of decentralised participants.

20. Method according to any of the above claims, characterised in that participants involved in the innovation process receive notifications by e-mail, telephone or SMS text message.

21. Method according to any of the above claims, characterised in that the data arising in the innovation process can be converted and output in formats for mobile communications applications.

22. System for interactive implementation of a planning process that is defined by a sequence of process steps, having:
a graphical user interface (6);
at least one application server (7), that provides the software tools (3) necessary for the execution of the process steps of the planning process and which can be accessed by means of the graphical user interface, and
a central database server (1), which exchanges input and output data for the software tools with the at least one application server (7) and manages these input and output data.

22. System for interactive implementation of a planning process that is defined by a sequence of process steps, having:
a computer network (25),
a central ASP server (7), on which the individual steps of the planning process are present as modules (9, 10) and which users of terminals (23) access via the computer network (25), by means of graphical user interfaces, whereby
each module (9, 10) represents a sequence of individual process steps,
in order to execute a module (9, 10) from a terminal (23), that is linked with the ASP server (7) computer network (25), the corresponding module (9, 10) can be invoked by means of a graphical user interface (6) of the terminal (23) and thereby the application programs (3) in the ASP server (7) necessary for the execution of the module (9, 10) are automatically invoked,
the process data resulting from the execution of a module (9, 10) are handed over to a central database (1), and
the process data present in the central database (1) are invoked again during the execution of a subsequent module.

23. System according to claim 22, characterised in that the software tools (3) are made available alternatively or additionally on the database server (1).

24. System for interactive implementation of a planning process according to claim 23, characterised in that the at least one application server (7) makes available status data, that indicate the current state of the planning process.

25. System for interactive implementation of a planning process according to any of claims 22 to 24, characterised in that a project management module (10) is provided that uses the status data for quality, time and/or cost control purposes or for control of other company resources.

26. System according to any of claims 22 to 25, characterised in that it has an integrated idea management module.

27. System according to any of claims 22 to 26, characterised in that it has an integrated expert network.

28. System according to any of claims 22 to 27, characterised in that interactive input possibilities, such as interactive whiteboards, flipcharts and so on are connected via an integrated software application.

29. System according to any of claims 22 to 28, characterised in that it also has a management planning nodule that organises daily tasks and for the participants in the innovation process generates automated suggestions for prioritization of activities concerning the innovation process.

30. Computer program product that in the loaded state in the memory of a network computer performs a method according to any of claims 1 to 19.
